(19) United States
(12) Patent Application Publication
(10) Pub. No.: US 2015/0018068 A1
(43) Pub. Date: Jan. 15, 2015

(54) GAMING MACHINES, GAMING SYSTEMS AND METHODS OF AWARDING WILD SYMBOLS DURING PLAY OF A GAMING MACHINE GAME

(71) Applicant: Bally Gaming, Inc., Las Vegas, NV (US)

(72) Inventors: William Wadleigh, Las Vegas, NV (US); Alex Shatsky, Las Vegas, NV (US); David Schultz, Henderson, NV (US); Michael Mitchell, Las Vegas, NV (US); Keith Kruczynski, Las Vegas, NV (US)

(73) Assignee: Bally Gaming, Inc., Las Vegas, NV (US)

(21) Appl. No.: 13/940,452

(22) Filed: Jul. 12, 2013

(51) Int. Cl. G07F 17/34

(52) U.S. Cl. CPC G07F 17/34
USPC 463/20

(57) ABSTRACT

Disclosed are gaming machines and gaming machine systems and methods including a feature game in which a player is awarded one or more wild symbols. In one embodiment, the number of wild symbols awarded is derived from a number of special symbol occurrences during preliminary play of the game. In another embodiment, each play of a plurality of plays enables an additional symbol in a symbol set as a wild symbol for the remaining duration of the game.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention is directed to wagering games, gaming machines, networked gaming systems and methods and, more particularly, to wagering games, gaming machines, networked gaming systems and methods having a simulated musical interface.

2. Description of the Related Art

Gaming devices such as casino gaming devices, e.g. slot machines, have been popular for over a century. In general, a gaming machine allows a player to play a game in exchange for a wager. Depending on the outcome of the game, the player may be entitled to an award which is paid to the player by the gaming machine, normally in the form of currency or game credits. Gaming machines may include flashing displays, lighted displays, or sound effects to capture a player's interest in a gaming device.

Initially such devices were mechanical devices presenting one or more mechanical spinning reels to randomly select and display winning or losing outcomes at a single pay line. Modernly such devices are computer controlled and some include video displays, electromechanical stepper controlled physical reels or combinations thereof. Typically these devices display game features of a base game and perhaps one or more bonus or secondary games. For example, for a video device, the game may present a base game depicting video images of five reels each with three display positions, i.e. coordinates producing a 3×5 matrix of positions for symbols. One or more pay lines are provided. Under control of the computer processor the video display depicts the reels spinning and stopping to arrange the game symbols in the matrix and where a predetermined winning combination of symbols is obtained on a wagered upon (i.e. enabled) pay line or pay arrangement the player receives a prize. Of course the foregoing description should not be deemed to be limiting since awards may be issued for symbols scattered in the matrix, i.e. a “scatter pay” and some symbols may trigger additional features such as a secondary game.

Some gaming machine games today include one or more progressive prize awards. In some configurations, the progressive prize may have a small probability of a player winning it; thus making it possible to have a larger progressive prize. In other game configurations, the progressive prize may be a small amount; thus allowing the player patron to win the progressive prize more frequently. In most typical game configurations, the player wins the progressive prize as a result of a specific game outcome within the primary or main game.

Another important feature of maintaining player interest in a gaming machine includes providing the player with many opportunities to win awards, such as cash or prizes. For example, in some slot machines, the display windows show more than one adjacent symbol on each reel, thereby allowing for multiple-line betting. Feature games of various types have been employed to reward players above the amounts normally awarded on a standard game pay schedule. Generally, such feature games are triggered by predetermined events such as one or more appearances of certain combinations of indicia in a primary game. In order to stimulate interest, feature games are typically set to occur at a gaming machine on a statistical cycle based upon the number of primary game plays. Feature games may include free spins of the base game, alteration of the base game for a number of spins, e.g. making one or more symbols wild or altering the symbol sets for the reels, a game where a player makes selections to reveal one or more prizes or otherwise interacts with a game feature to produce, or try to produce, an additional award. These different features to captivate and maintain player interest.

While gaming machines including feature games with wild symbols have been successful, there remains a need for such feature games that provide players with enhanced excitement. In particular, there remains a need for a game in which a player is awarded wild symbols in a new and entertaining way.

### SUMMARY OF THE INVENTION

In accordance with one or more embodiments, a method of operating a wagering game for a gaming machine including a non-transitory memory device and executed by a processor of the gaming machine includes the steps of initializing a tally; presenting a plurality of games comprising spinning one of more symbol-bearing reels to produce a game outcome and, for each special symbol displayed as part of the game outcome, incrementing the tally. Upon conclusion of the presentation of the plurality of games, the steps further include presenting an additional game outcome including spinning the one of more symbol-bearing reels to produce an additional game outcome, wherein, one or more of the symbols displayed as part of the additional outcome is replaced by one or more wild symbols, the number of symbols replaced by wild symbols determined by the tally.

In accordance with one or more other embodiments, a method of operating a wagering game for a gaming machine including a non-transitory memory device and executed by a processor of the gaming machine includes the steps of presenting a plurality of games, each of the plurality of games including designating a symbol as a designated symbol and spinning one of more symbol-bearing reels to produce a game outcome and, for each designated symbol displayed as part of the game outcome, treating that symbol as a wild symbol in evaluating the game outcome for any winning combinations of symbols; and retaining the wild characteristic of the designated symbol for all subsequent games in the plurality of games.

Other features and advantages will become apparent from the following detailed description, taken in conjunction with the accompanying drawings, which illustrate by way of example, the features of the various embodiments.

### BRIEF DESCRIPTION OF THE DRAWINGS

FIGS. 1-13A show various displays in accordance with one or more embodiments of the invention, as described more fully below.

FIG. 14 is a perspective view of a gaming machine in accordance with one or more embodiments.

FIGS. 15A and B are a block diagram of the physical and logical components of the gaming machine of FIG. 14 in accordance with one or more embodiments.

FIG. 16 is a block diagram of the logical components of a gaming kernel in accordance with one or more embodiments.

FIGS. 17A and B are a schematic block diagram showing the hardware elements of a networked gaming system in accordance with one or more embodiments.

FIG. 18 is a schematic block diagram showing the hardware elements of a networked gaming system which may provide various applications which can be accessed and delivered to personal computers and various portable computing devices in accordance with one or more embodiments.

### DETAILED DESCRIPTION OF THE EMBODIMENTS

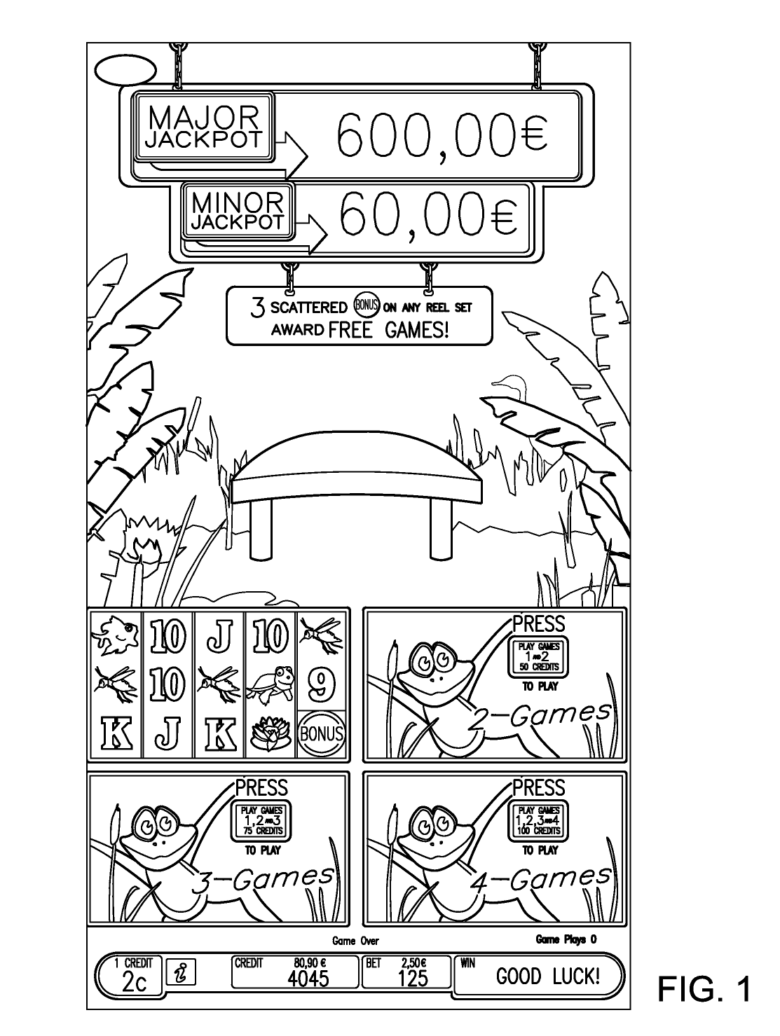

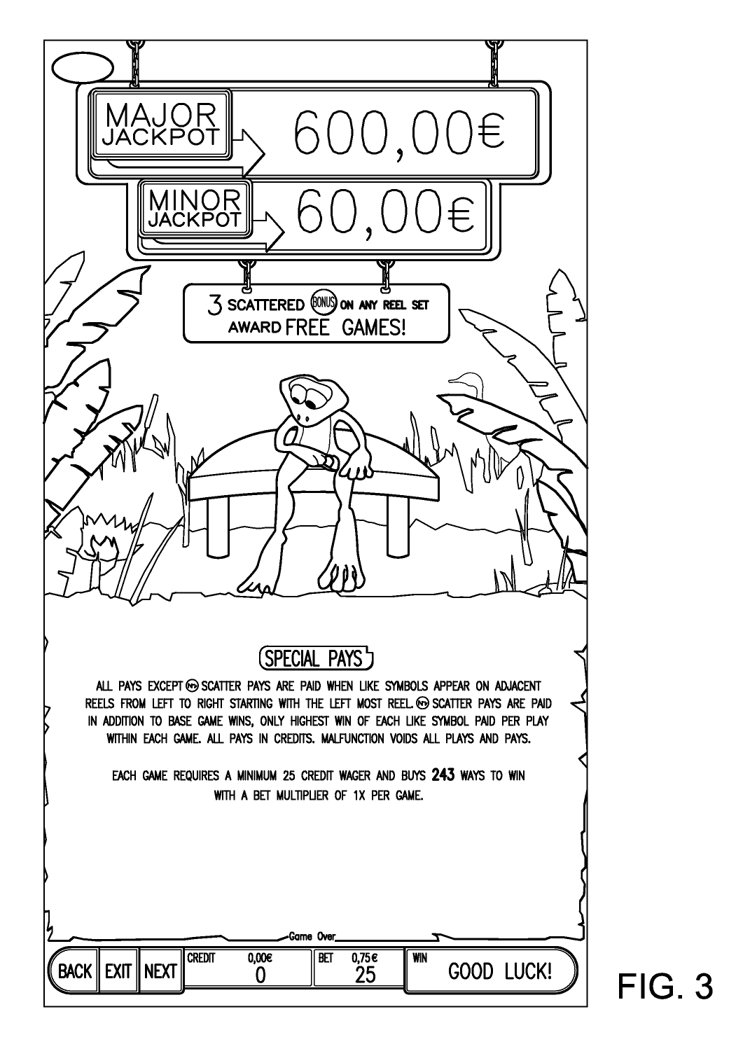

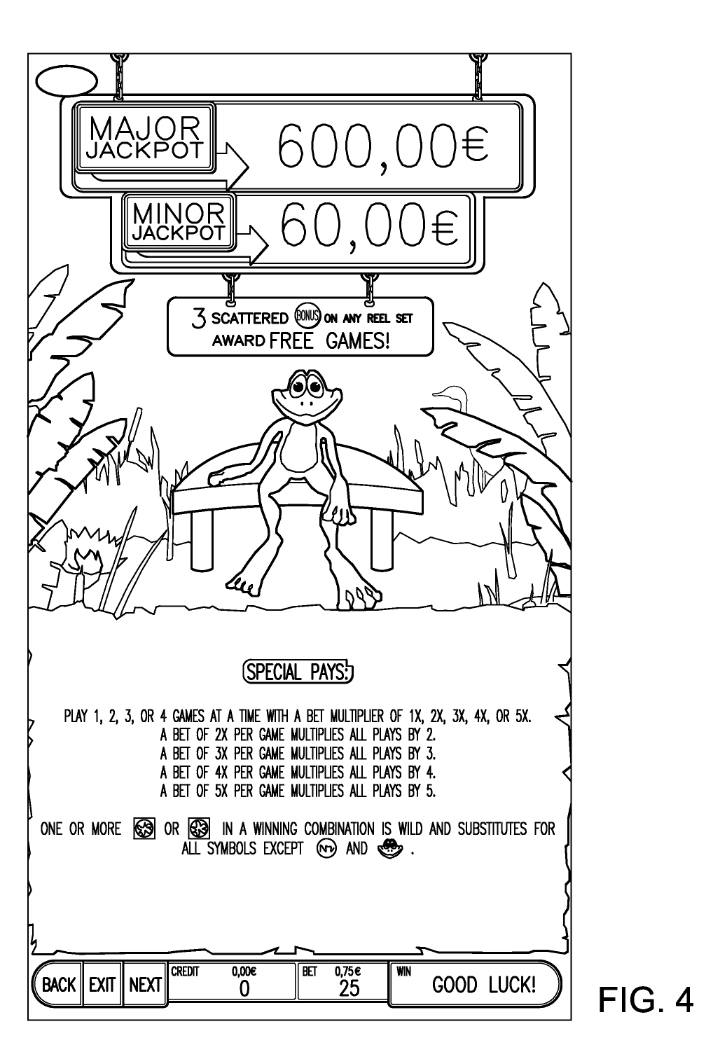

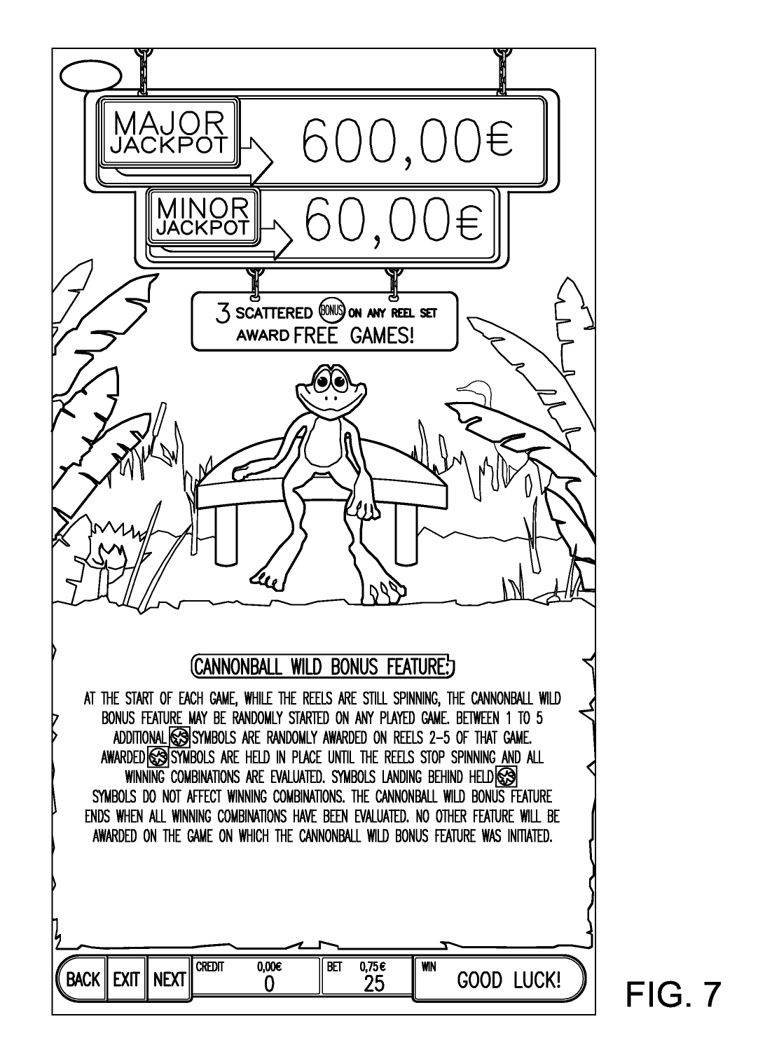

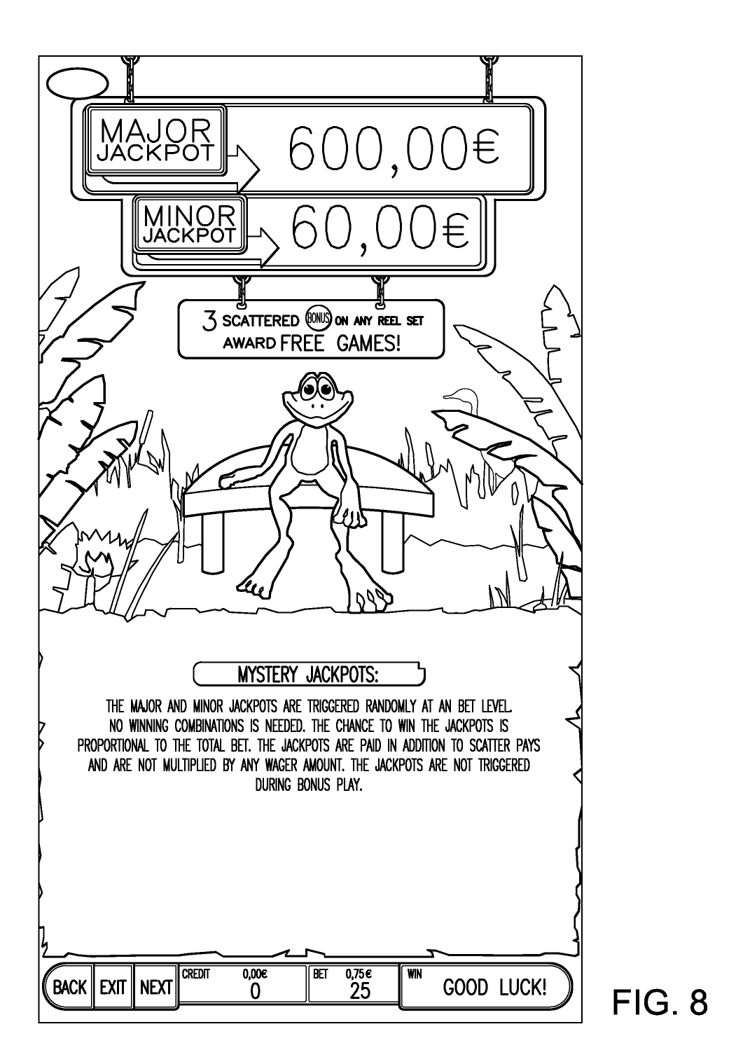

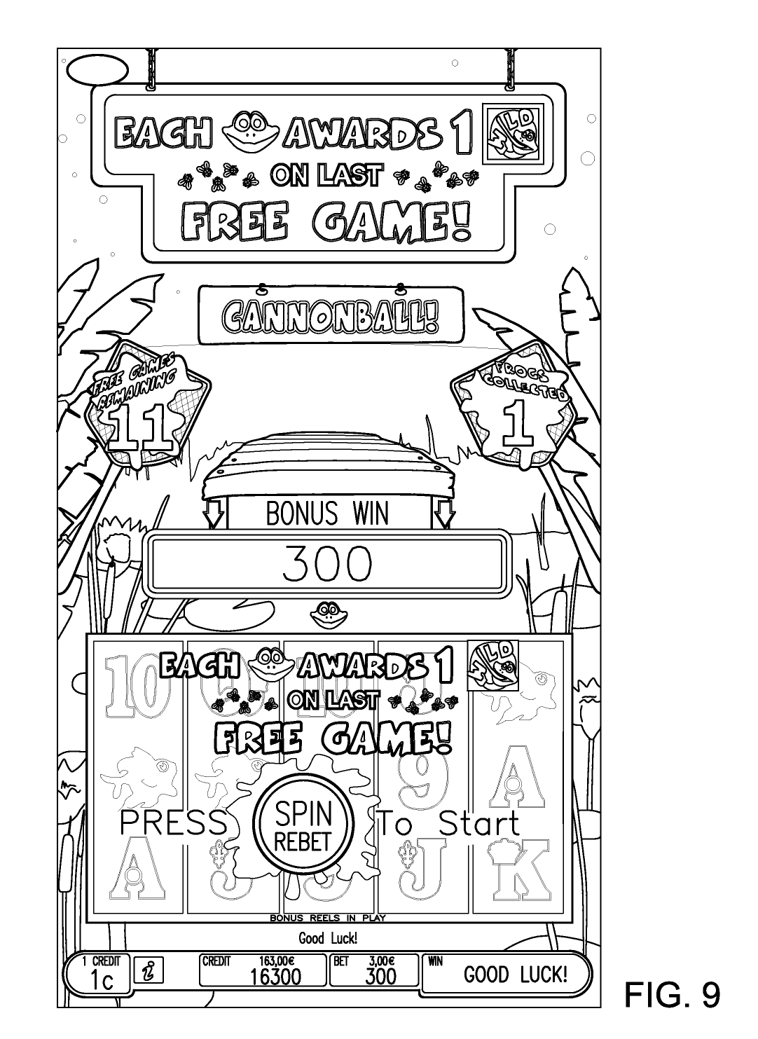

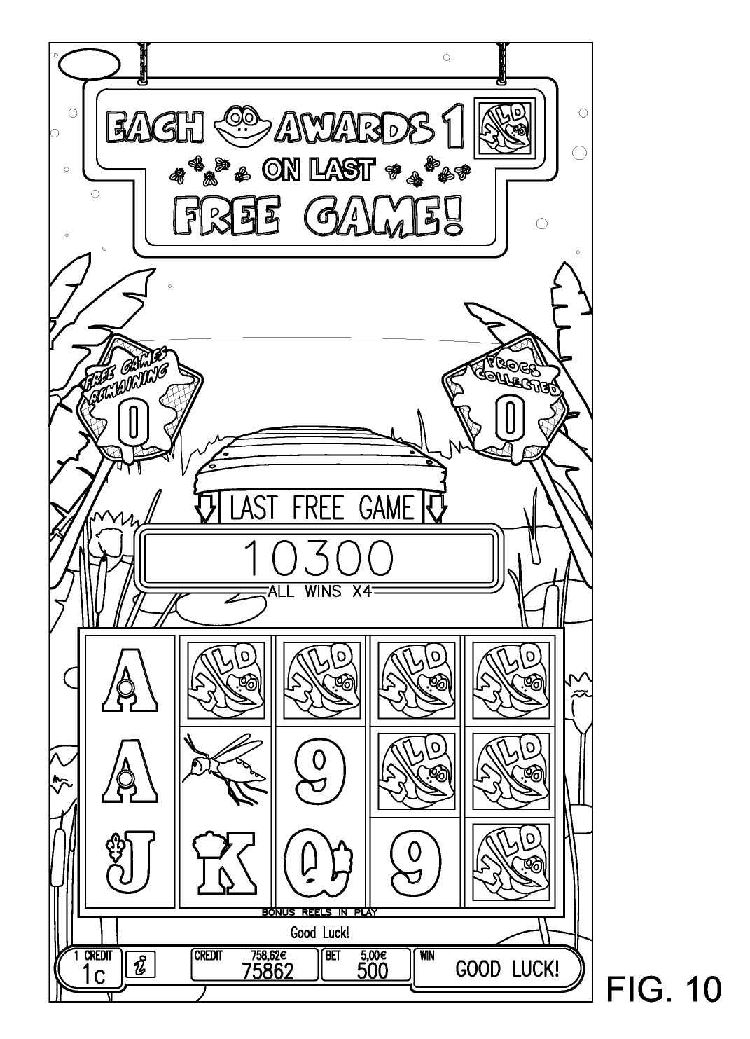

Referring now to the drawings, and more particularly to FIGS. 1-18, there are shown illustrative examples of games, gaming machines and gaming networks suitable for implementing a game in accordance with various aspects of the invention. In a slot machine according to various embodiments, a number of pay line patterns pass through one symbol on each of, for example, five reels. For example, a first pay line may extend horizontally through the middle row of each of the five reels. The invention can be implemented with any number of reels and any number of selected symbols appearing to trigger the bonus feature. The number of pay lines and their patterns are by way of example only and may vary. The player selects the number of played pay lines and the number of credits or coins wagered on each line using touch screen controls or gaming device control buttons and initiates play, whereby the reels spin for a period of time before stopping to display an outcome which is then analyzed for any winning combinations. A winning combination, for example, could be three or more symbols adjacent to one another on an active pay line. For each winning combination, the game device awards the player the award in an associated pay table, adjusted as necessary based on the number of credits wagered on the pay line on which the win occurred. For example, three symbols adjacent to one another from left-to-right on an active pay line might pay 100 times the player's wager.

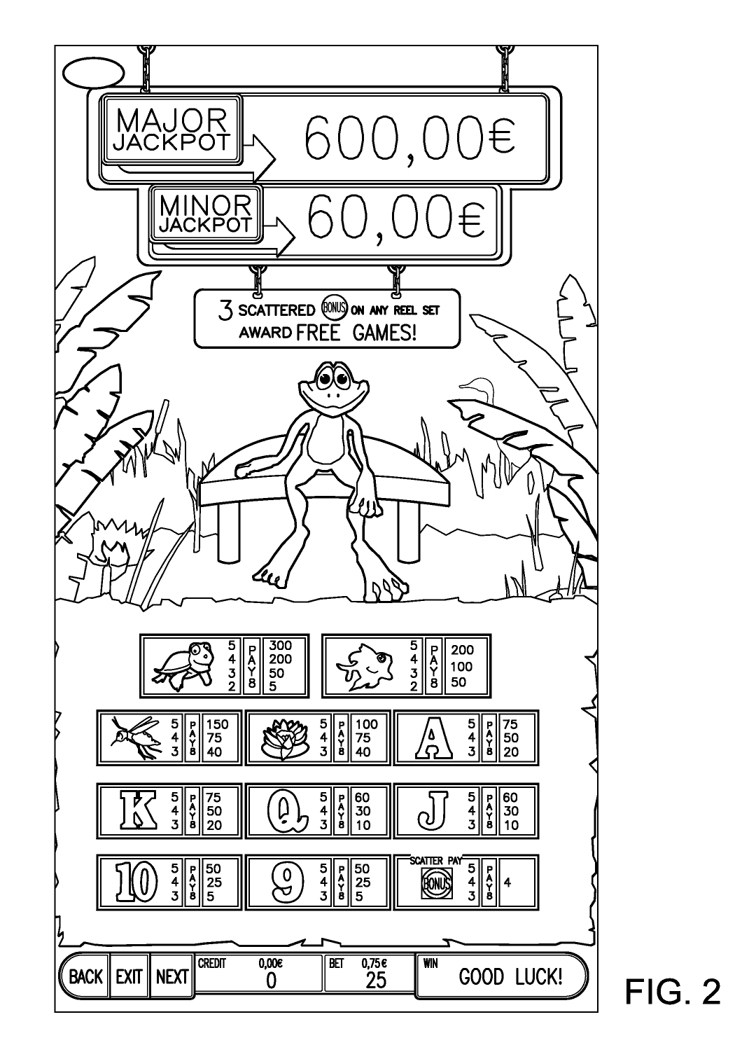

In accordance with one embodiment, the player may play up to four base games simultaneously, as illustrated by FIG. 1. Each game can be purchased by way of wagering controls. For example, in FIG. 1, the upper left of four games may be played for a wager of 25 credits. As shown, up to three additional games may be played, “Play games 1& 2—50 credits, play games 1, 2 &3—75 credits, play games 1, 2 3 & 4, 100 credits”) The game screen also displays two progressive meters (major and minor) as well as a “dashboard” containing a bet meter, win meter and current denomination setting. One or more “help screens” describing the operation of the game and its rules, as illustrated by FIGS. 2-8 in accordance with one or more embodiments, may be accessed by pressing an information icon (“i”) on the screen.

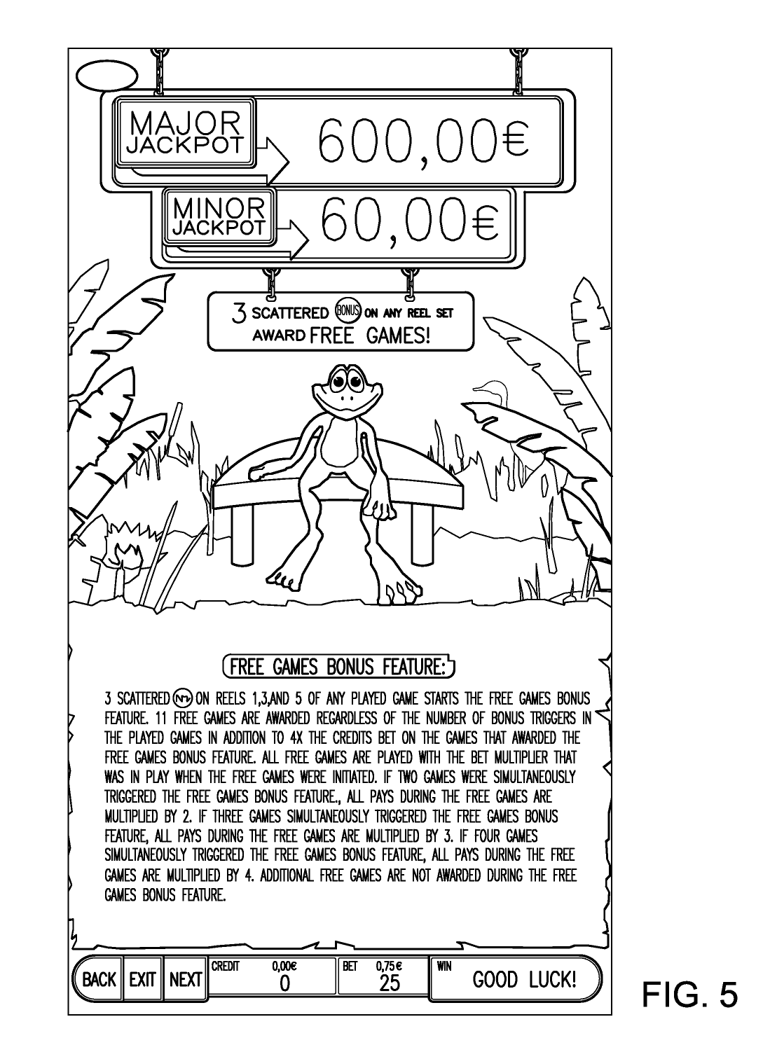

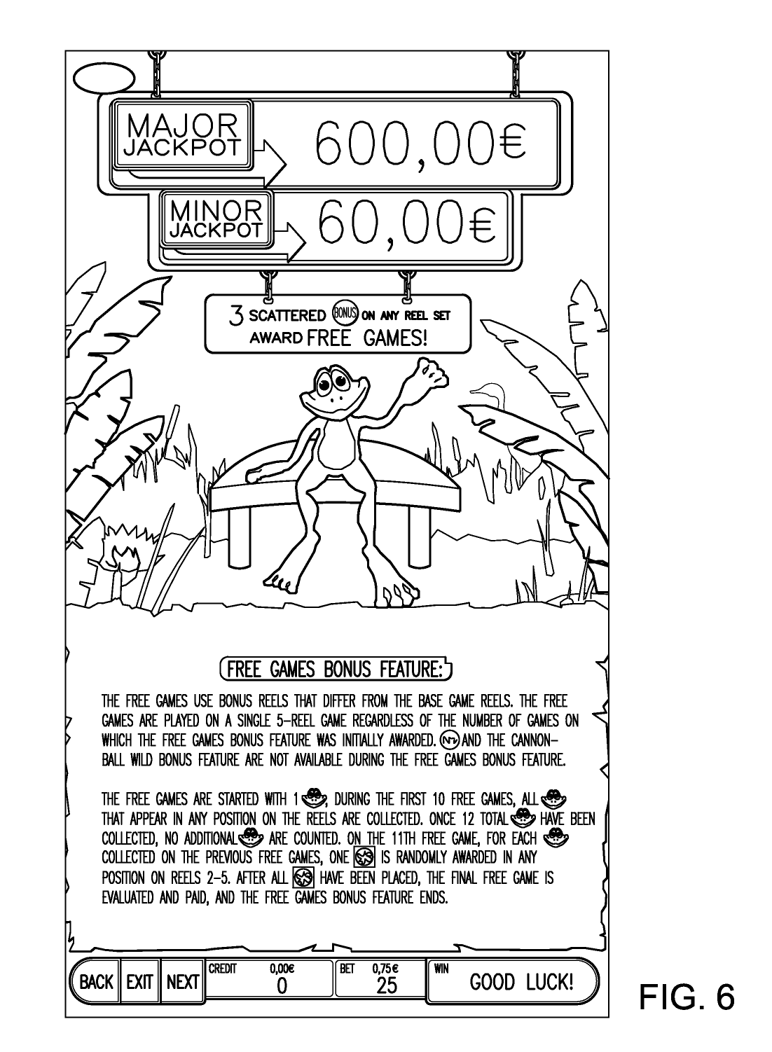

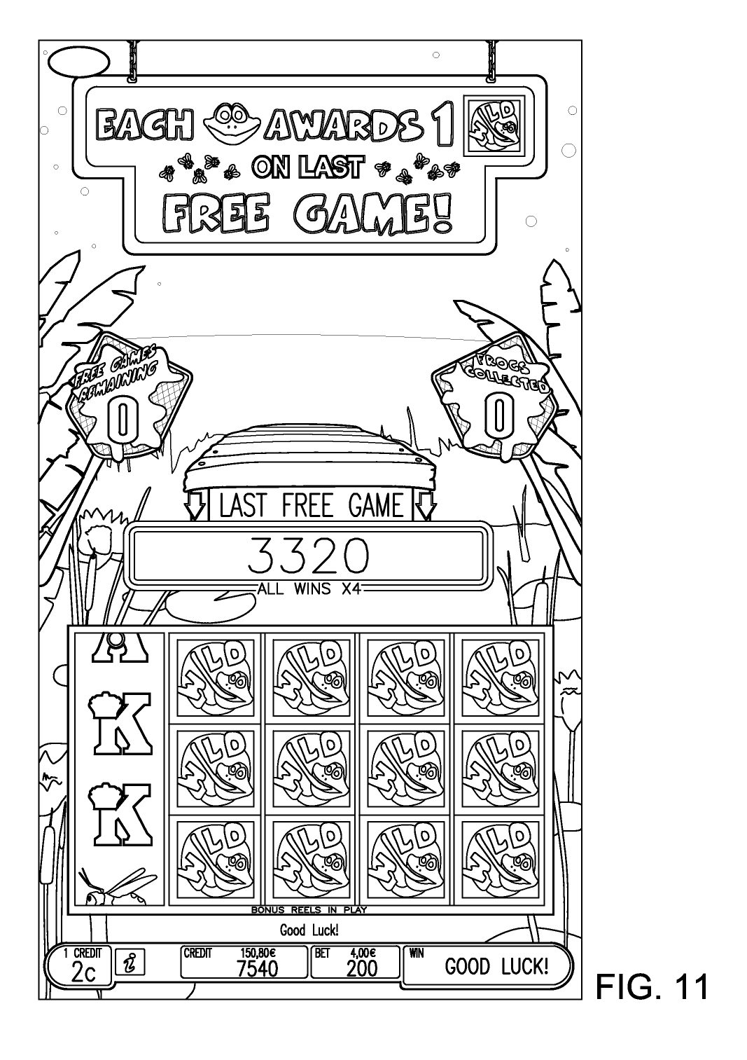

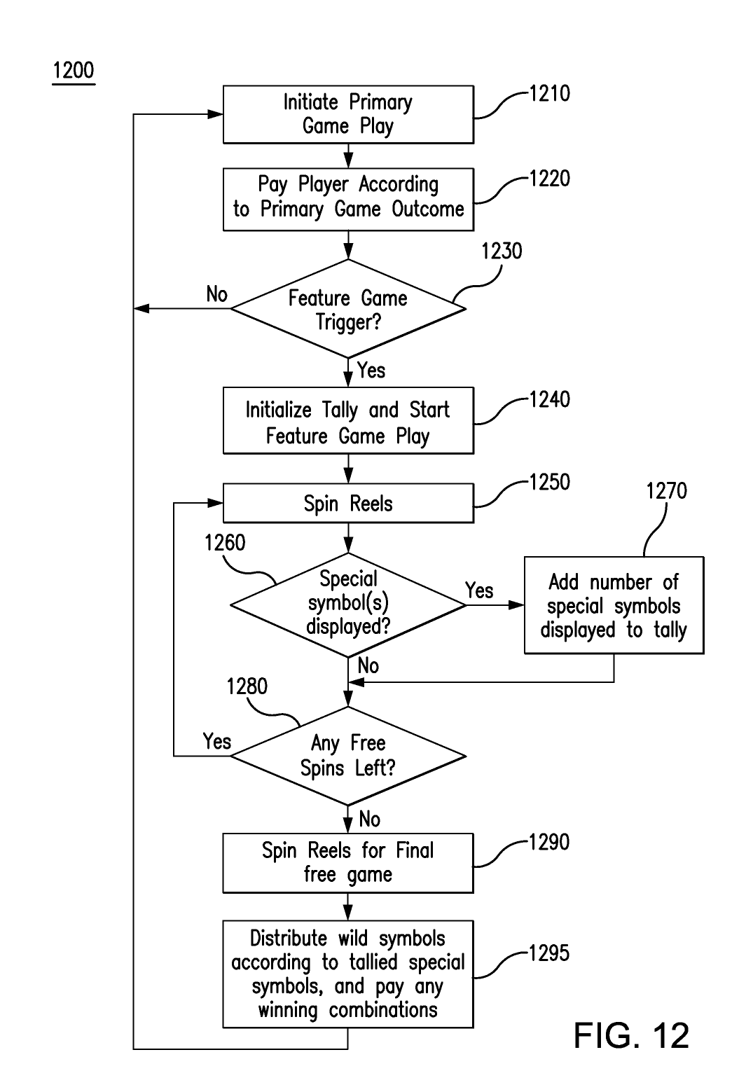

In particular, FIG. 6 illustrates a method of awarding a feature game with random wild symbols that provides the player with a number of randomly placed wild symbols, the number of wild symbols correlated to a number of special symbols collected during the free game round. In the example, one or more base games trigger play of the free game, as illustrated by FIG. 5. Once triggered, the free game round is initiated. (FIG. 11). In the free game round, the player seeks to collect special symbols (“frog” symbols, in this example) during a series of spins of a special set of bonus reels on which special symbols and other indicia are displayed. During the first 10 free games, all special symbols that appear in any position on the reels are tallied on a meter. Any winning combinations of symbols are paid according to a pay table, as shown, for example, in FIG. 2. In one or more embodiments, the pays may be multiplied depending on how many base game outcomes triggered the free game round. (FIG. 5) On an 11^{th} and final free game, after the game has spun and stopped, one wild symbol is randomly placed for each of the tallied special symbols. In the example, of FIG. 12, seven special symbols were collected during the initial spins and have been distributed on the reels. After all the wild symbols are placed, the final free game result is evaluated against a pay table and paid. In some embodiments, there may not be a one-to-one correspondence of special symbols to awarded wild symbols, but the number of awarded wild symbols will be, at least, based on the number of special symbols tallied during the initial spins of the game.

In accordance with another embodiment, the placement of wild symbols may be restricted to a particular area of the reels, for example, only on reels 2-5. This creates a situation in which it is no longer advantageous to collect additional special symbols. In the example game of the illustrations, reels 2-5 provide a maximum of 12 locations which can randomly receive a wild symbol. Once a maximum of 12 special symbols have been tallied, no additional “frog symbols” are tallied (FIG. 6). In the final free game, all available spaces are filled with wild symbols, as shown in FIG. 11. In accordance with other embodiments, a fixed placement scheme is used to place the number of symbols achieved by tallying special symbols.

In accordance with one or more embodiments of the invention, progressive prizes may be awarded as part of game play. In one or more embodiments, one or more triggering events may award one or more progressive prizes. In some embodiments, these events are tied to game outcomes. In other embodiments, these events may be “mystery” events (FIG. 8) The progressive prizes may be calculated by a progressive controller such as a controller manufactured by Mikohn, Inc. The progressive controller monitors wagering during base game play, calculates a current value for one or more progressive jackpot pools and transmits the current pool values to the gaming machine. In one or more embodiments, progressive awards are accumulated during regular play as a percentage, such as three percent, of the game play take. The prizes may be sized according to the preferences of the casino operator. The number of prizes may vary without deviating from the scope of the invention. The size of the prizes is dependent on the amount of play prior to initiating feature play and may come from the contributions of a single gaming machine or a number of linked gaming machines. In another aspect, the prizes may be set amounts established by the casino operator from non-coin-in funds, such as marketing funds.

In one or more embodiments, the prizes for feature game play may be accumulated based on funding mechanisms other than a percentage of wagers accumulated by the gaming machine. For example, an operator may initially fund various award pools with a pre-determined amount of money, such as $1000 for one progressive, $500 for a second progressive, $100 for a third progressive and so on. Subsequently, the casino operator may determine to increase the amounts of one or more of the awards at pre-determined times which may be periodically or randomly selected with a range of times or periods. Once a winner has occurred at any level, the award levels may be rolled back to the initial funding level. In one or more embodiments, only the winning award level is rolled back to the initial funding level.

In one or more embodiments, the prizes for feature game play may be set amounts, i.e. non-progressive. In one or more embodiments, the algorithms to determine the amounts may be determined by a statistical percentage based on an average take of a gaming machine and the likelihood of the win over a period of time. In the case where one or more gaming machines are networked, a common award table may be utilized where the award algorithms are determined based on an average take (total wagers) of all the networked gaming machines and the likelihood of a win of an award over a period of time. Each award may be calculated in a similar manner based on the likelihood of a winning outcome being achieved during a game play session.

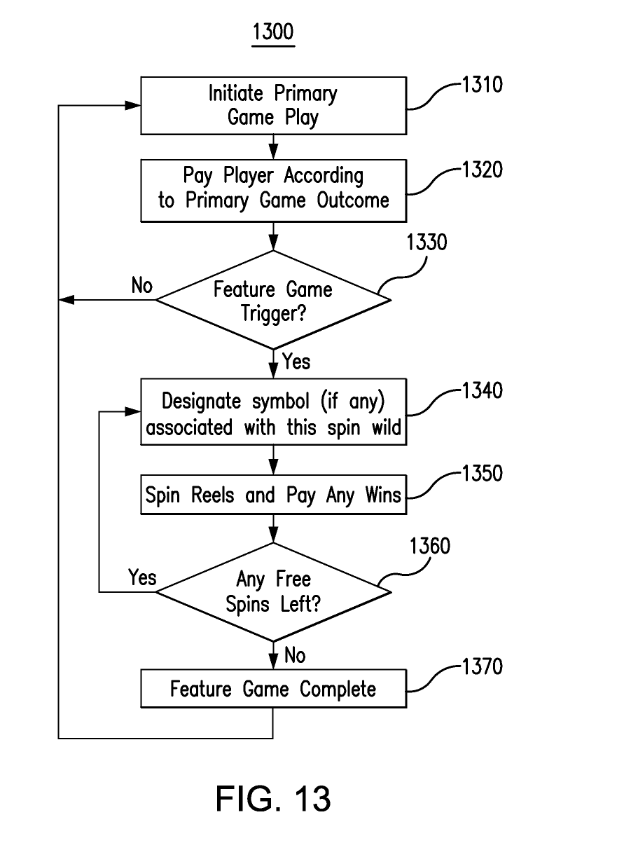

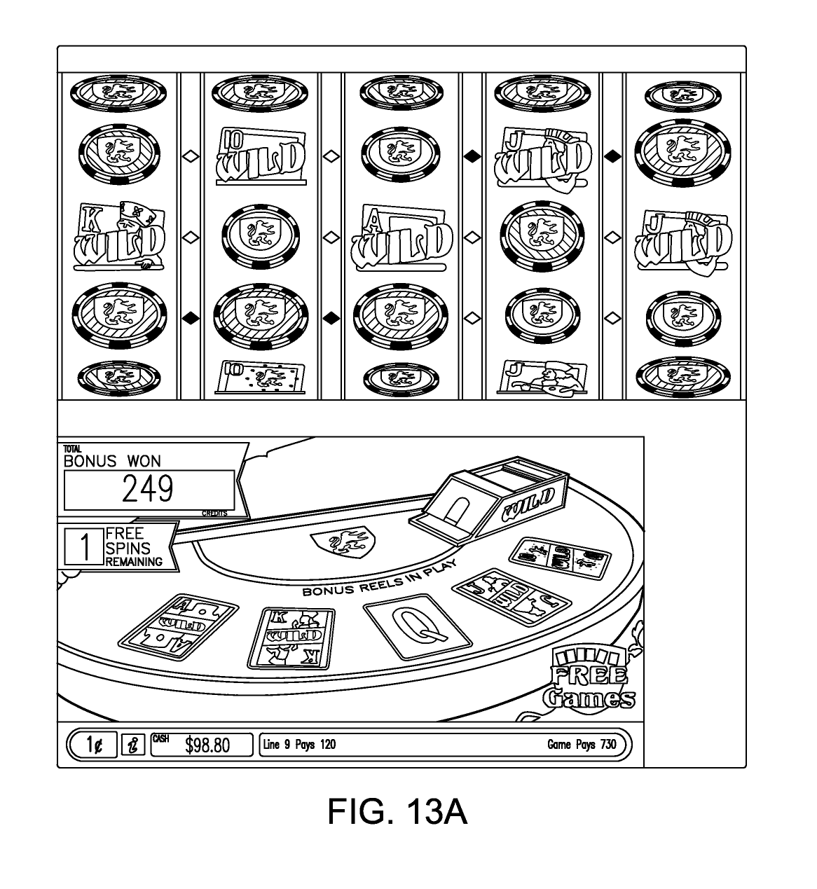

In accordance with other embodiments providing wild symbols to a player, as illustrated by FIG. 13, in a game having similar base characteristics of the game illustrated in FIGS. 1-2, in which at least one feature game may be triggered, one additional symbol on the reels becomes wild for each spin within a series of free games. Each reel symbol that becomes wild is shown to the player prior to the first spin on which it will be wild. Each symbol that becomes wild remains wild for the remainder of the series, thus excitement and reward potential build as more symbols become “wild” as the bonus progresses. For example, in one embodiment using card symbols, five free spins are awarded to the player. On each spin, an additional one of the cards “Ace”, “King”, “Queen”, “Jack” or “Ten” becomes wild. (FIG. 13A) In another embodiment, for example, a number of various gem symbols may become wild as the bonus progresses. Methods of “converting” the symbols to wild may include, but are not limited to, converting symbols on a one-to-one relationship between the current spin of the bonus event and a particular symbol. For example, in the gems embodiment, the “citrine” symbol (dark yellow) may always be the first gem to be converted, followed by the “amethyst” symbol (purple), “sapphire” symbol (blue), “emerald” symbol (green), “ruby” symbol (red) and “diamond” symbol (white). Again, once a symbol is converted it remains converted for the duration of the bonus event.

In other embodiments, each spin of the bonus may be associated with a particular type of symbol. For example, all “Bars”, all “7's” or all symbols that contain a certain marking or common graphical element may be converted to wild on their associated spin. In still other embodiments, symbols may be converted on a one to one relationship between the current spin of the bonus and the position/pay level of the symbol. For example, the most prevalent symbols on the reels, lowest pays on the pay table, may be converted on the first spin. The second-most prevalent symbol on the reel, second lowest pay on the pay table, may be converted on the second spin, and so on. In one or more embodiments, an iconic representation of the current total number of converted symbols along with those symbols that have not yet been converted may be displayed.

In various embodiments, by way of non-limiting example, converted symbols may be visually converted simultaneously, may be converted in reel order (left to right, right to left, etc.), converted according to their order in the pay table (ascending or descending value), are converted in an order specified by player input.

In some embodiments, converted symbols are converted on a single spin basis or for a group of spins rather than for all remaining spins or converted symbols remain converted until a secondary event or outcome such as a “no win” or other event occurs. In other embodiments, only symbols on a particular reel or subset of reels may be convertible.

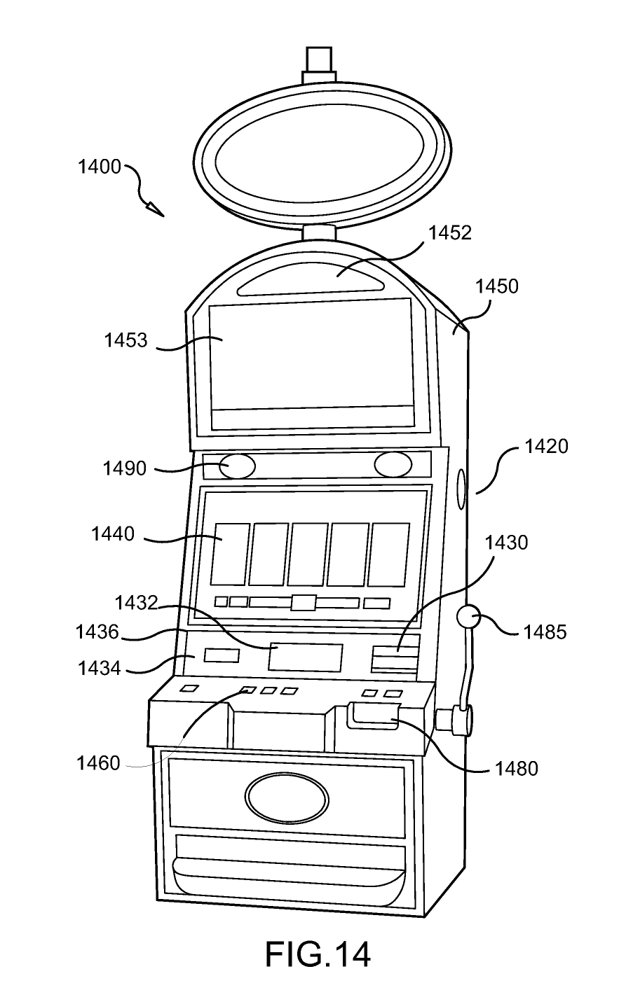

Referring to FIG. 14, gaming machine 1400 capable of supporting various embodiments of the invention is shown, including cabinet housing 1420, primary game display 1440 upon which a primary game and feature game may be displayed, top box 1450 which may display multiple progressives that may be won during play of the feature game, player-activated buttons 1460, player tracking panel 1436, bill/voucher acceptor 1480 and one or more speakers 1490. Cabinet housing 1420 may be a self-standing unit that is generally rectangular in shape and may be manufactured with reinforced steel or other rigid materials which are resistant to tampering and vandalism. Cabinet housing 1420 may alternatively be a handheld device including the gaming functionality as discussed herein and including various of the described components herein. For example, a handheld device may be a cell phone, personal data assistant, or laptop or tablet computer, each of which may include a display, a processor, and memory sufficient to support either stand-alone capability such as gaming machine 400 or thin client capability such as that incorporating some of the capability of a remote server.

In one or more embodiments, cabinet housing 1420 houses a processor, circuitry, and software (not shown) for receiving signals from the player-activated buttons 1460, operating the games, and transmitting signals to the respective displays and speakers. Any shaped cabinet may be implemented with any embodiment of gaming machine 1400 so long as it provides access to a player for playing a game. For example, cabinet 1420 may comprise a slant-top, bar-top, or table-top style cabinet, including a Bally Cinevision™ or CineReels™ cabinet. The operation of gaming machine 1400 is described more fully below.

The plurality of player-activated buttons 1460 may be used for various functions such as, but not limited to, selecting a wager denomination, selecting a game to be played, selecting a wager amount per game, initiating a game, or cashing out money from gaming machine 400. Buttons 460 may be operable as input mechanisms and may include mechanical buttons, electromechanical buttons or touch screen buttons. Optionally, a handle 1485 may be rotated by a player to initiate a game.

In one or more embodiments, buttons 1460 may be replaced with various other input mechanisms known in the art such as, but not limited to, a touch screen system, touch pad, track ball, mouse, switches, toggle switches, or other input means used to accept player input such as a Bally iDeck™. One other example input means is a universal button module as disclosed in U.S. application Ser. No. 11/106,212, entitled “Universal Button Module,” filed on Apr. 14, 2005, which is hereby incorporated by reference. Generally, the universal button module provides a dynamic button system adaptable for use with various games and capable of adjusting to gaming systems having frequent game changes. More particularly, the universal button module may be used in connection with playing a game on a gaming machine and may be used for such functions as selecting the number of credits to bet per hand.

Cabinet housing 1420 may optionally include top box 1450 which contains “top glass” 1452 comprising advertising or payout information related to the game or games available on gaming machine 1400. Player tracking panel 1436 includes player tracking card reader 1434 and player tracking display 1432. Voucher printer 1430 may be integrated into player tracking panel 1436 or installed elsewhere in cabinet housing 1420 or top box 1450.

Game display 1440 may present a game of chance wherein a player receives one or more outcomes from a set of potential outcomes. For example, one such game of chance is a video slot machine game. In other aspects of the invention, gaming machine 1400 may present a video or mechanical reel slot machine, a video keno game, a lottery game, a bingo game, a Class II bingo game, a roulette game, a craps game, a blackjack game, a mechanical or video representation of a wheel game or the like.

Mechanical or video/mechanical embodiments may include game displays such as mechanical reels, wheels, or dice as required to present the game to the player. In video/mechanical or pure video embodiments, game display 1440 is, typically, a CRT or a flat-panel display in the form of, but not limited to, liquid crystal, plasma, electroluminescent, vacuum fluorescent, field emission, or any other type of panel display known or developed in the art. Game display 1440 may be mounted in either a “portrait” or “landscape” orientation and be of standard or “widescreen” dimensions (i.e., a ratio of one dimension to another of at least 16×9). For example, a widescreen display may be 32 inches wide by 18 inches tall. A widescreen display in a “portrait” orientation may be 32 inches tall by 18 inches wide. Additionally, game display 440 preferably includes a touch screen or touch glass system (not shown) and presents player interfaces such as, but not limited to, credit meter (not shown), win meter (not shown) and touch screen buttons (not shown). An example of a touch glass system is disclosed in U.S. Pat. No. 6,942,571, entitled “Gaming Device with Direction and Speed Control of Mechanical Reels Using Touch Screen,” which is hereby incorporated by reference in its entirety for all purposes.

Game display 1440 may also present information such as, but not limited to, player information, advertisements and casino promotions, graphic displays, news and sports updates, or even offer an alternate game. This information may be generated through a host computer networked with gaming machine 1400 on its own initiative or it may be obtained by request of the player using either one or more of the plurality of player-activated buttons 1460; the game display itself, if game display 1440 comprises a touch screen or similar technology; buttons (not shown) mounted about game display 1440 which may permit selections such as those found on an ATM machine, where legends on the screen are associated with respective selecting buttons; or any player input device that offers the required functionality.

Cabinet housing 1420 incorporates a single game display 1440. However, in alternate embodiments, cabinet housing 1420 or top box 1450 may house one or more additional displays 1453 or components used for various purposes including additional game play screens, animated “top glass,” progressive meters or mechanical or electromechanical devices (not shown) such as, but not limited to, wheels, pointers or reels. The additional displays may or may not include a touch screen or touch glass system.

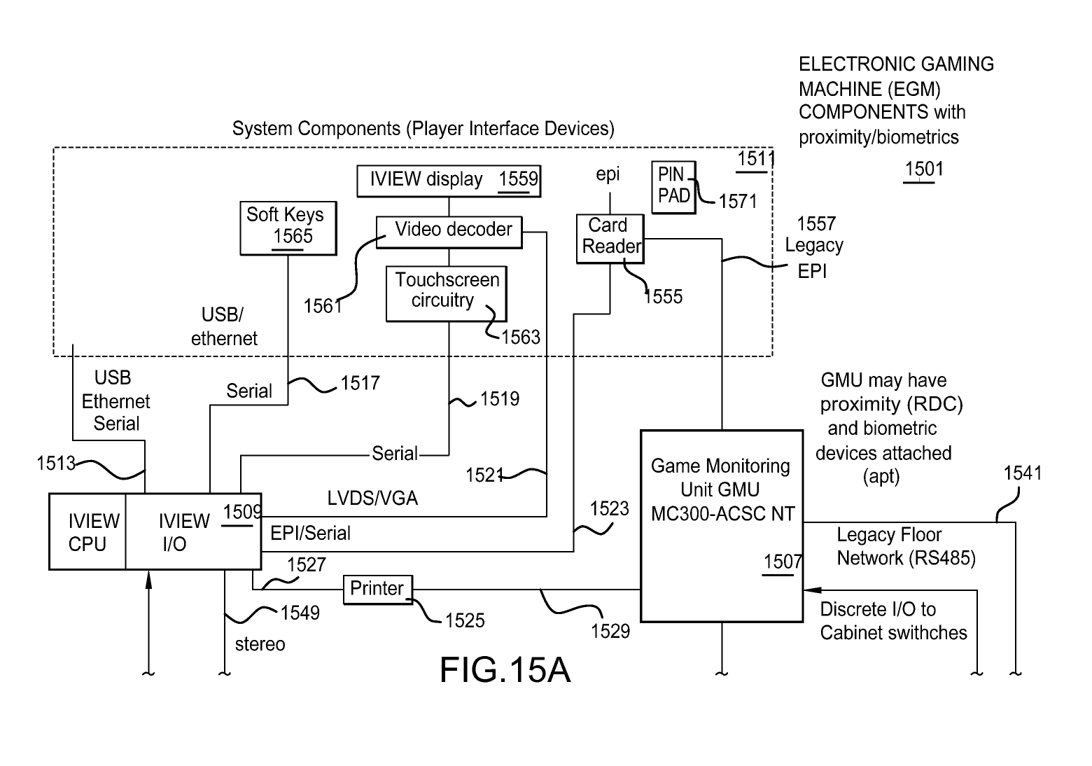

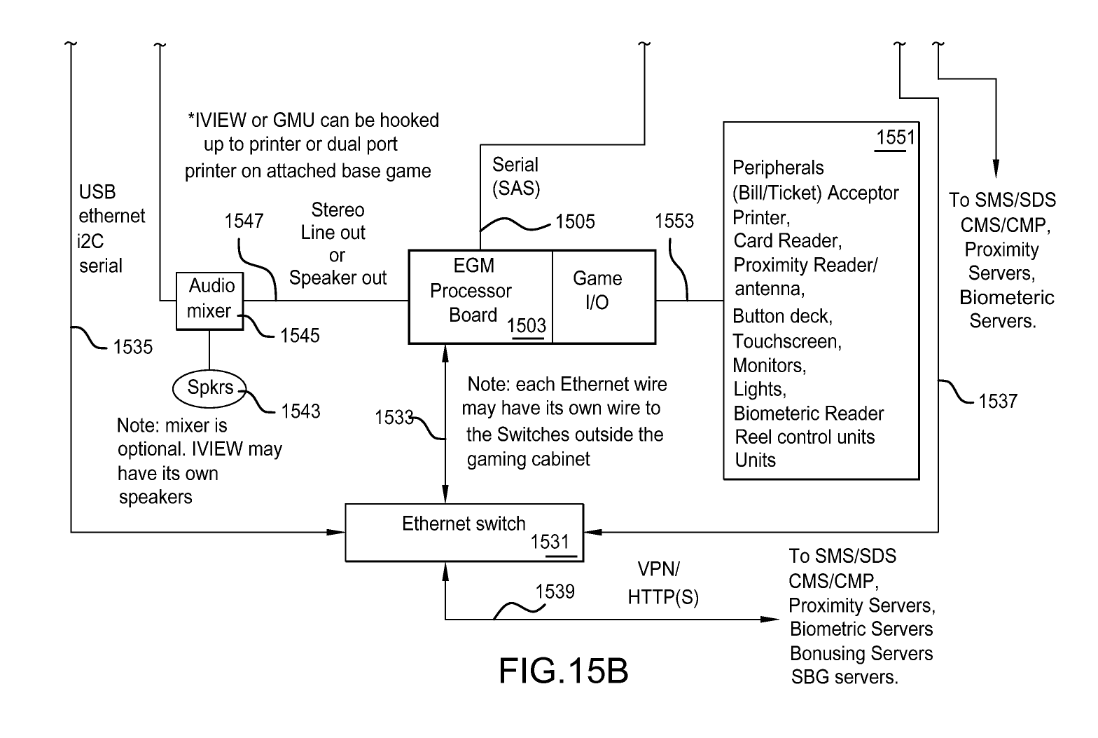

Referring to FIGS. 15A and B, electronic gaming machine 1501 is shown in accordance with one or more embodiments. Electronic gaming machine 1501 includes base game integrated circuit board 1503 (EGM Processor Board) connected through serial bus line 1505 to game monitoring unit (GMU) 1507 (such as a Bally MC300 or ACSC NT), and player interface integrated circuit board (PIB) 1509 connected to player interface devices 1511 over bus lines 1513, 1515, 1517, 1519, 1521, 1523. Printer 1525 is connected to PIB 1509 and GMU 1507 over bus lines 1527, 1529. Base game integrated circuit board 1503, PIB 1509, and GMU 1507 connect to Ethernet switch 1531 over bus lines 1533, 1535, 1537. Ethernet switch 1531 connects to a slot management system (SMS) and a casino management system (CMS) network over bus line 1539. GMU 1507 also may connect to the SMS and CMS network over bus line 1541. Speakers 1543 connect through audio mixer 1545 and bus lines 1547, 1549 to base game integrated circuit board 1503 and PIB 1509. The proximity and biometric devices and circuitry may be installed by upgrading a commercially available PIB 1509, such as a Bally iView unit. Coding executed on base game integrated circuit board 1503, PIB 1509, and/or GMU 1507 may be upgraded to integrate a game having adjustable multi-part indicia as is more fully described herein.

Peripherals 1551 connect through i/o board 1553 to base game integrated circuit board 1503. For example, a bill/ticket acceptor is typically connected to a game input-output board 1553 which is, in turn, connected to a conventional central processing unit (“CPU”) base game integrated circuit board 1503, such as an Intel Pentium microprocessor mounted on a gaming motherboard. I/O board 1553 may be connected to base game integrated circuit board 1503 by a serial connection such as RS-232 or USB or may be attached to the processor by a bus such as, but not limited to, an ISA bus. The gaming motherboard may be mounted with other conventional components, such as are found on conventional personal computer motherboards, and loaded with a game program which may include a gaming machine operating system (OS), such as a Bally Alpha OS. Base game integrated circuit board 1503 executes a game program that causes base game integrated circuit board 1503 to play a game. In one embodiment, the game program provides a slot machine game having adjustable multi-part indicia. The various components and included devices may be installed with conventionally and/or commercially available components, devices, and circuitry into a conventional and/or commercially available gaming machine cabinet, examples of which are described above.

When a player has inserted a form of currency such as, for example and without limitation, paper currency, coins or tokens, cashless tickets or vouchers, electronic funds transfers or the like into the currency acceptor, a signal is sent by way of I/O board 1553 to base game integrated circuit board 1503 which, in turn, assigns an appropriate number of credits for play in accordance with the game program. The player may further control the operation of the gaming machine by way of other peripherals 1551, for example, to select the amount to wager via electromechanical or touch screen buttons. The game starts in response to the player operating a start mechanism such as a handle or touch screen icon. The game program includes a random number generator to provide a display of randomly selected indicia on one or more displays. In some embodiments, the random generator may be physically separate from gaming machine 1500; for example, it may be part of a central determination host system which provides random game outcomes to the game program. Thereafter, the player may or may not interact with the game through electromechanical or touch screen buttons to change the displayed indicia. Finally, base game integrated circuit board 1503 under control of the game program and OS compares the final display of indicia to a pay table. The set of possible game outcomes may include a subset of outcomes related to the triggering of a feature game. In the event the displayed outcome is a member of this subset, base game integrated circuit board 1503, under control of the game program and by way of I/O Board 1553, may cause feature game play to be presented on a feature display.

Predetermined payout amounts for certain outcomes, including feature game outcomes, are stored as part of the game program. Such payout amounts are, in response to instructions from base game integrated circuit board 1503, provided to the player in the form of coins, credits or currency via I/O board 1553 and a pay mechanism, which may be one or more of a credit meter, a coin hopper, a voucher printer, an electronic funds transfer protocol or any other payout means known or developed in the art.

In various embodiments, the game program is stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In one embodiment, the remote storage device is housed in a remote server. The gaming machine may access the remote storage device via a network connection, including but not limited to, a local area network connection, a TCP/IP connection, a wireless connection, or any other means for operatively networking components together. Optionally, other data including graphics, sound files and other media data for use with the EGM are stored in the same or a separate memory device (not shown). Some or all of the game program and its associated data may be loaded from one memory device into another, for example, from flash memory to random access memory (RAM).

In one or more embodiments, peripherals may be connected to the system over Ethernet connections directly to the appropriate server or tied to the system controller inside the EGM using USB, serial or Ethernet connections. Each of the respective devices may have upgrades to their firmware utilizing these connections.

GMU 1507 includes an integrated circuit board and GMU processor and memory including coding for network communications, such as the G2S (game-to-system) protocol from the Gaming Standards Association, Las Vegas, Nev., used for system communications over the network. As shown, GMU 1507 may connect to card reader 1555 through bus 1557 and may thereby obtain player card information and transmit the information over the network through bus 1541. Gaming activity information may be transferred by the base game integrated circuit board 1503 to GMU 1507 where the information may be translated into a network protocol, such as S2S, for transmission to a server, such as a player tracking server, where information about a player's playing activity may be stored in a designated server database.

PIB 1509 includes an integrated circuit board, PID processor, and memory which includes an operating system, such as Windows CE, a player interface program which may be executable by the PID processor together with various input/output (I/O) drivers for respective devices which connect to PIB 1509, such as player interface devices 511, and which may further include various games or game components playable on PIB 1509 or playable on a connected network server and PIB 1509 is operable as the player interface. PIB 1509 connects to card reader 1555 through bus 1523, display 1559 through video decoder 1561 and bus 1521, such as an LVDS or VGA bus.

As part of its programming, the PID processor executes coding to drive display 1559 and provide messages and information to a player. Touch screen circuitry interactively connects display 1559 and video decoder 1561 to PIB 1509, such that a player may input information and cause the information to be transmitted to PIB 1509 either on the player's initiative or responsive to a query by PIB 1509. Additionally soft keys 1565 connect through bus 1517 to PIB 1509 and operate together with display 1559 to provide information or queries to a player and receive responses or queries from the player. PIB 1509, in turn, communicates over the CMS/SMS network through Ethernet switch 1531 and busses 1535, 1539 and with respective servers, such as a player tracking server.

Player interface devices 1511 are linked into the virtual private network of the system components in gaming machine 1501. The system components include the iVIEW processing board and game monitoring unit (GMU) processing board. These system components may connect over a network to the slot management system (such as a commercially available Bally SDS/SMS) and/or casino management system (such as a commercially available Bally CMP/CMS).

The GMU system component has a connection to the base game through a serial SAS connection and is connected to various servers using, for example, HTTPs over Ethernet. Through this connection, firmware, media, operating system software, gaming machine configurations can be downloaded to the system components from the servers. This data is authenticated prior to install on the system components.

The system components include the iVIEW processing board and game monitoring unit (GMU) processing board. The GMU and iVIEW can combined into one like the commercially available Bally GTM iVIEW device. This device may have a video mixing technology to mix the EGM processor's video signals with the iVIEW display onto the top box monitor or any monitor on the gaming device.

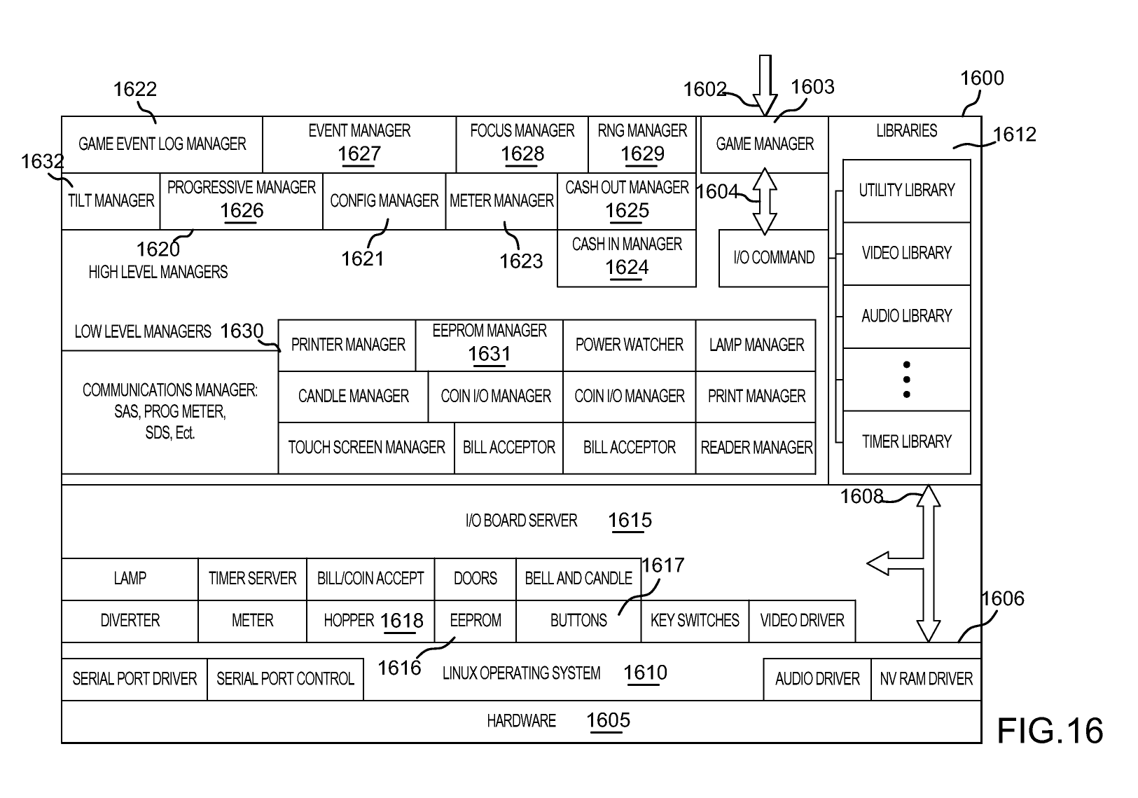

In accordance with one or more embodiments, FIG. 16 is a functional block diagram of a gaming kernel 1600 of a game program under control of base game integrated circuit board 1503. The game program uses gaming kernel 1600 by calling into application programming interface (API) 1602, which is part of game manager 1603. The components of game kernel 1600 as shown in FIG. 16 are only illustrative, and should not be considered limiting. For example, the number of managers may be changed, additional managers may be added or some managers may be removed without deviating from the scope and spirit of the invention.

As shown in the example, there are three layers: a hardware layer 1605; an operating system layer 1610, such as, but not limited to, Linux; and a game kernel layer 1600 having game manager 1603 therein. In one or more embodiments, the use of a standard operating system 1610, such a UNIX-based or Windows-based operating system, allows game developers interfacing to the gaming kernel to use any of a number of standard development tools and environments available for the operating systems. This is in contrast to the use of proprietary, low level interfaces which may require significant time and engineering investments for each game upgrade, hardware upgrade, or feature upgrade. The game kernel layer 1600 executes at the user level of the operating system 1610, and itself contains a major component called the I/O Board Server 1615. To properly set the bounds of game application software (making integrity checking easier), all game applications interact with gaming kernel 1600 using a single API 1602 in game manager 1603. This enables game applications to make use of a well-defined, consistent interface, as well as making access points to gaming kernel 1600 controlled, where overall access is controlled using separate processes.

For example, game manager 1603 parses an incoming command stream and, when a command dealing with I/O comes in (arrow 1604), the command is sent to an applicable library routine 1612. Library routine 1612 decides what it needs from a device, and sends commands to I/O Board Server 1615 (see arrow 1608). A few specific drivers remain in operating system 1610's kernel, shown as those below line 1606. These are built-in, primitive, or privileged drivers that are (i) general (ii) kept to a minimum and (iii) are easier to leave than extract. In such cases, the low-level communications is handled within operating system 1610 and the contents passed to library routines 1612.

Thus, in a few cases library routines may interact with drivers inside operating system 1610, which is why arrow 1608 is shown as having three directions (between library utilities 1612 and I/O Board Server 1615, or between library utilities 1612 and certain drivers in operating system 1610). No matter which path is taken, the logic needed to work with each device is coded into modules in the user layer of the diagram. Operating system 1610 is kept as simple, stripped down, and common across as many hardware platforms as possible. The library utilities and user-level drivers change as dictated by the game cabinet or game machine in which it will run. Thus, each game cabinet or game machine may have an base game integrated circuit board 1503 connected to a unique, relatively dumb, and as inexpensive as possible I/O adapter board 1540, plus a gaming kernel 1600 which will have the game-machine-unique library routines and I/O Board Server 1615 components needed to enable game applications to interact with the gaming machine cabinet. Note that these differences are invisible to the game application software with the exception of certain functional differences (i.e., if a gaming cabinet has stereo sound, the game application will be able make use of API 1602 to use the capability over that of a cabinet having traditional monaural sound).

Game manager 1603 provides an interface into game kernel 1600, providing consistent, predictable, and backwards compatible calling methods, syntax, and capabilities by way of game application API 1602. This enables the game developer to be free of dealing directly with the hardware, including the freedom to not have to deal with low-level drivers as well as the freedom to not have to program lower level managers 1630, although lower level managers 630 may be accessible through game manager 1603's interface 1602 if a programmer has the need. In addition to the freedom derived from not having to deal with the hardware level drivers and the freedom of having consistent, callable, object-oriented interfaces to software managers of those components (drivers), game manager 1603 provides access to a set of upper level managers 1620 also having the advantages of consistent callable, object-oriented interfaces, and further providing the types and kinds of base functionality required in casino-type games. Game manager 1603, providing all the advantages of its consistent and richly functional interface 1602 as supported by the rest of game kernel 1600, thus provides a game developer with a multitude of advantages.

Game manager 1603 may have several objects within itself, including an initialization object (not shown). The initialization object performs the initialization of the entire game machine, including other objects, after game manager 1603 has started its internal objects and servers in appropriate order. In order to carry out this function, the kernel's configuration manager 1621 is among the first objects to be started; configuration manager 1621 has data needed to initialize and correctly configure other objects or servers.

The upper level managers 1620 of game kernel 1600 may include game event log manager 1622 which provides, at the least, a logging or logger base class, enabling other logging objects to be derived from this base object. The logger object is a generic logger; that is, it is not aware of the contents of logged messages and events. The log manager's (1622) job is to log events in non-volatile event log space. The size of the space may be fixed, although the size of the logged event is typically not. When the event space or log space fills up, one embodiment will delete the oldest logged event (each logged event will have a time/date stamp, as well as other needed information such as length), providing space to record the new event. In this embodiment, the most recent events will thus be found in the log space, regardless of their relative importance. Further provided is the capability to read the stored logs for event review.

In accordance with one embodiment, meter manager 1623 manages the various meters embodied in the game kernel 1600. This includes the accounting information for the game machine and game play. There are hard meters (counters) and soft meters; the soft meters may be stored in non-volatile storage such as non-volatile battery-backed RAM to prevent loss. Further, a backup copy of the soft meters may be stored in a separate non-volatile storage such as EEPROM. In one embodiment, meter manager 1623 receives its initialization data for the meters, during startup, from configuration manager 1621. While running, the cash in (1624) and cash out (1625) managers call the meter manager's (1623) update functions to update the meters. Meter manager 1623 will, on occasion, create backup copies of the soft meters by storing the soft meters' readings in EEPROM. This is accomplished by calling and using EEPROM manager 1631.

In accordance with still other embodiments, progressive manager 1626 manages progressive games playable from the game machine. Event manager 1627 is generic, like log manager 1622, and is used to manage various gaming machine events. Focus manager 628 correlates which process has control of various focus items. Tilt manager 1632 is an object that receives a list of errors (if any) from configuration manager 1621 at initialization, and during game play from processes, managers, drivers, etc. that may generate errors. Random number generator manager 1629 is provided to allow easy programming access to a random number generator (RNG), as a RNG is required in virtually all casino-style (gambling) games. RNG manager 1629 includes the capability of using multiple seeds.

In accordance with one or more embodiments, a credit manager object (not shown) manages the current state of credits (cash value or cash equivalent) in the game machine, including any available winnings, and further provides denomination conversion services. Cash out manager 1625 has the responsibility of configuring and managing monetary output devices. During initialization, cash out manager 1625, using data from configuration manager 1621, sets the cash out devices correctly and selects any selectable cash out denominations. During play, a game application may post a cash out event through the event manager 1627 (the same way all events are handled), and using a callback posted by cash out manager 1625, cash out manager 1625 is informed of the event. Cash out manager 1625 updates the credit object, updates its state in non-volatile memory, and sends an appropriate control message to the device manager that corresponds to the dispensing device. As the device dispenses dispensable media, there will typically be event messages being sent back and forth between the device and cash out manager 1625 until the dispensing finishes, after which cash out manager 1625, having updated the credit manager and any other game state (such as some associated with meter manager 1623) that needs to be updated for this set of actions, sends a cash out completion event to event manager 1627 and to the game application thereby. Cash in manager 624 functions similarly to cash out manager 1625, only controlling, interfacing with, and taking care of actions associated with cashing in events, cash in devices, and associated meters and crediting.

In a further example, in accordance with one or more embodiments, I/O server 1615 may write data to the gaming machine EEPROM memory, which is located in the gaming machine cabinet and holds meter storage that must be kept even in the event of power failure. Game manager 1603 calls the I/O library functions to write data to the EEPROM. The I/O server 1615 receives the request and starts a low priority EEPROM thread 1616 within I/O server 1615 to write the data. This thread uses a sequence of 8 bit command and data writes to the EEPROM device to write the appropriate data in the proper location within the device. Any errors detected will be sent as IPC messages to game manager 1603. All of this processing is asynchronous.

In accordance with one embodiment, button module 1617 within I/O server 1615, polls (or is sent) the state of buttons every 2 ms. These inputs are debounced by keeping a history of input samples. Certain sequences of samples are required to detect a button was pressed, in which case the I/O server 1615 sends an inter-process communication event to game manager 1603 that a button was pressed or released. In some embodiments, the gaming machine may have intelligent distributed I/O which debounces the buttons, in which case button module 1617 may be able to communicate with the remote intelligent button processor to get the button events and simply relay them to game manager 1603 via IPC messages. In still another embodiment, the I/O library may be used for pay out requests from the game application. For example, hopper module 1618 must start the hopper motor, constantly monitor the coin sensing lines of the hopper, debounce them, and send an IPC message to the game manager 1603 when each coin is paid.

Further details, including disclosure of lower level fault handling and/or processing, are included in U.S. Pat. No. 7,351,151 entitled “Gaming Board Set and Gaming Kernel for Game Cabinets” and provisional U.S. patent application No. 60/313,743, entitled “Form Fitting Upgrade Board Set For Existing Game Cabinets,” filed Aug. 20, 2001; said patent and provisional are both fully incorporated herein by explicit reference.

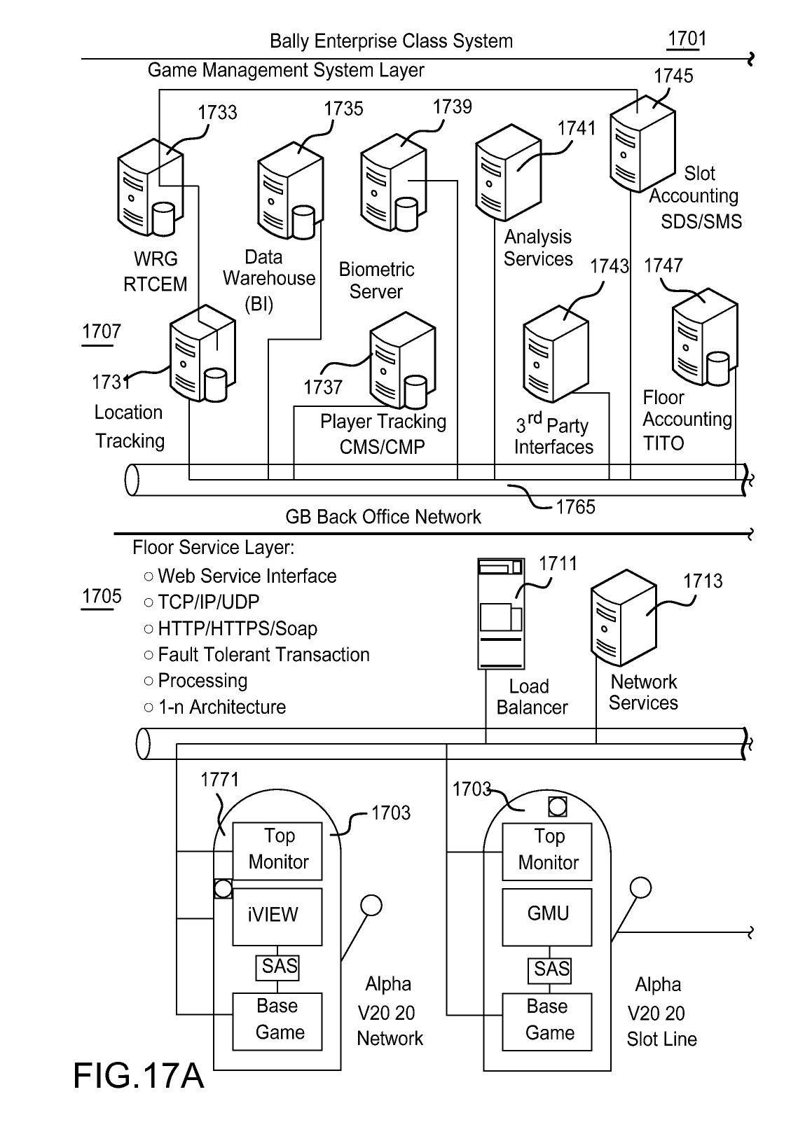

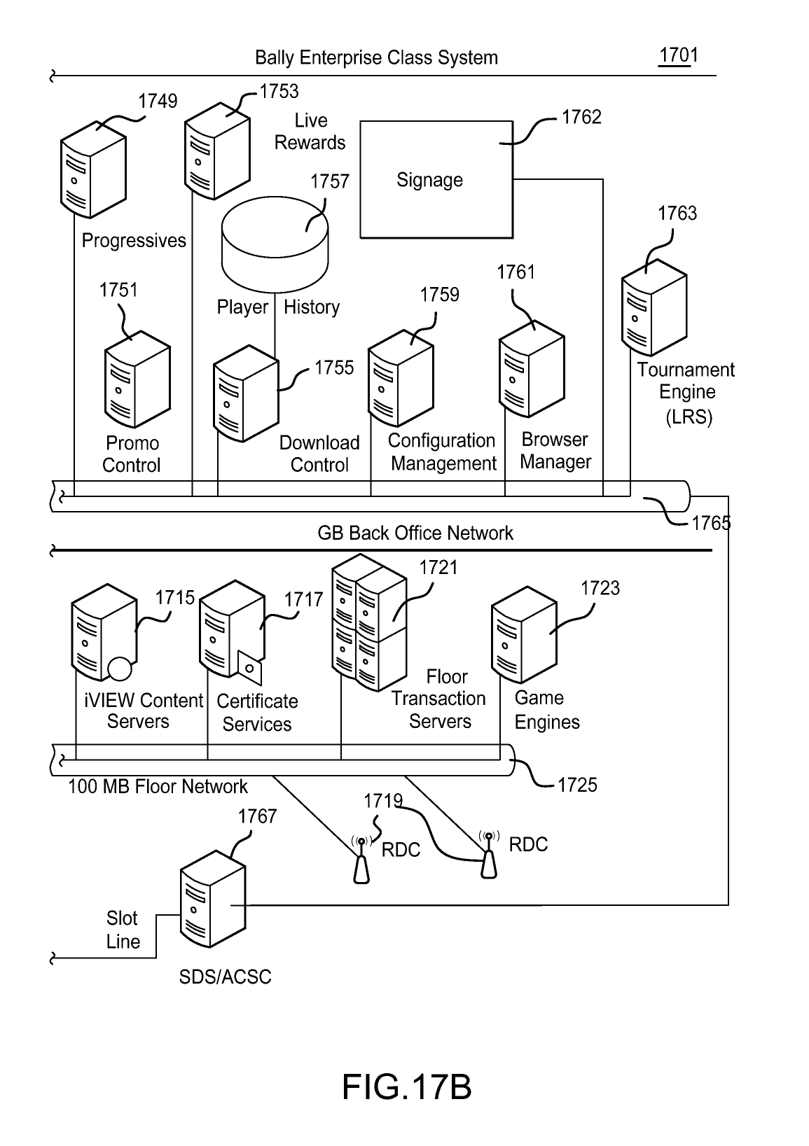

Referring to FIGS. 17A and B, enterprise gaming system 1701 is shown in accordance with one or more embodiments. Enterprise gaming system 1701 may include one casino or multiple locations and generally includes a network of gaming machines 1703, floor management system (SMS) 1705, and casino management system (CMS) 1707. SMS 1705 may include load balancer 1711, network services servers 1713, player interface (iVIEW) content servers 1715, certificate services server 1717, floor radio dispatch receiver/transmitters (RDC) 1719, floor transaction servers 1721 and game engines 1723, each of which may connect over network bus 1725 to gaming machines 1703. CMS 1707 may include location tracking server 1731, WRG RTCEM server 1733, data warehouse server 1735, player tracking server 1737, biometric server 1739, analysis services server 1741, third party interface server 1743, slot accounting server 1745, floor accounting server 1747, progressives server 1749, promo control server 1751, feature game (such as Bally Live Rewards) server 1753, download control server 1755, player history database 1757, configuration management server 1759, browser manager 1761, tournament engine server 1763 connecting through bus 1765 to server host 1767 and gaming machines 1703. The various servers and gaming machines 1703 may connect to the network with various conventional network connections (such as, for example, USB, serial, parallel, RS485, Ethernet). Additional servers which may be incorporated with CMS 1707 include a responsible gaming limit server (not shown), advertisement server (not shown), and a control station server (not shown) where an operator or authorized personnel may select options and input new programming to adjust each of the respective servers and gaming machines 1703. SMS 1705 may also have additional servers including a control station (not shown) through which authorized personnel may select options, modify programming, and obtain reports of the connected servers and devices, and obtain reports. The various CMS and SMS servers are descriptively entitled to reflect the functional executable programming stored thereon and the nature of databases maintained and utilized in performing their respective functions.

Gaming machines 1703 include various peripheral components that may be connected with USB, serial, parallel, RS-485 or Ethernet devices/architectures to the system components within the respective gaming machine. The GMU has a connection to the base game through a serial SAS connection. The system components in the gaming cabinet may be connected to the servers using HTTPs or G2S over Ethernet. Using CMS 1707 and/or SMS 1705 servers and devices, firmware, media, operating systems, and configurations may be downloaded to the system components of respective gaming machines for upgrading or managing floor content and offerings in accordance with operator selections or automatically depending upon CMS 1707 and SMS 1705 master programming. The data and programming updates to gaming machines 1703 are authenticated using conventional techniques prior to install on the system components.

In various embodiments, any of the gaming machines 1703 may be a mechanical reel spinning slot machine or a video slot machine or a gaming machine offering one or more of the above described games including a group play game. Alternately, gaming machines 1703 may provide a game with a simulated musical instrument interface as a primary or base game or as one of a set of multiple primary games selected for play by a random number generator. A gaming system of the type described above also allows a plurality of games in accordance with the various embodiments of the invention to be linked under the control of a group game server (not shown) for cooperative or competitive play in a particular area, carousel, casino or between casinos located in geographically separate areas. For example, one or more examples of group games under control of a group game server are disclosed in U.S. application Ser. No. 11/938,079, entitled “Networked System and Method for Group Play Gaming,” filed on Nov. 9, 2007, which is hereby incorporated by reference in its entirety for all purposes.

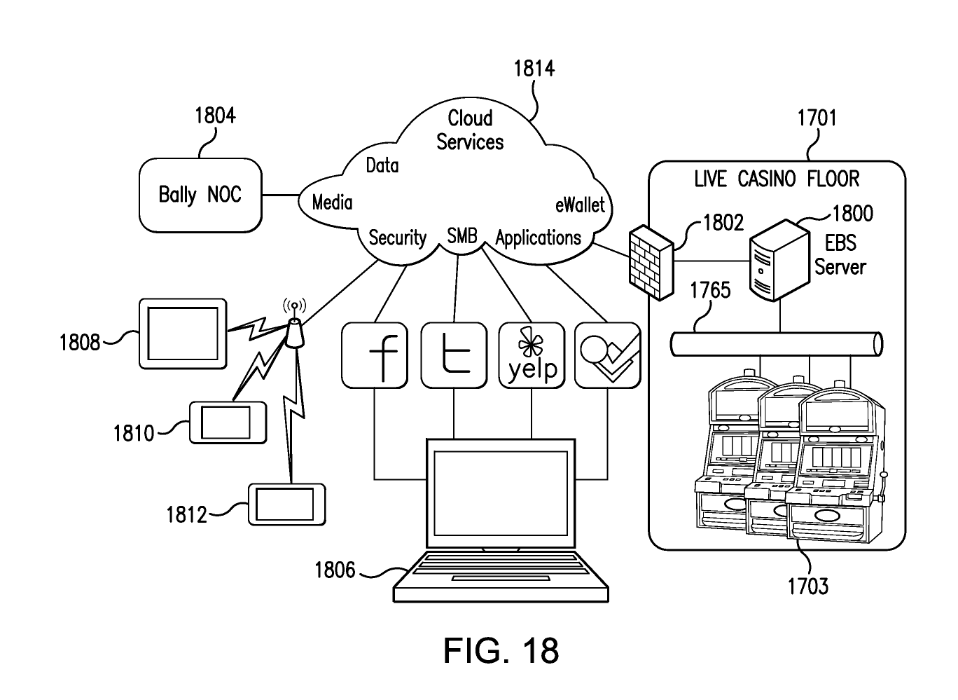

All or portions of the present invention may also be implemented or promoted by or through a system as suggested in FIG. 18. At 1701 is the gaming system of FIG. 17, which may be hosted at a casino property enterprise, across several casino enterprises or by a third party host. As described above the gaming system 1701 has a network communication bus 1765 providing for communication between the gaming terminals 1703 and various servers. To provide the functionality illustrated in FIG. 18, a bonusing server 1800, such as a Bally Elite Bonusing Server is connected to the network communication bus 1765 for communication to the gaming system 1701, the gaming terminals 1703 and the various servers and other devices as described above. Through a secure network firewall 1802 the bonusing server 1800 is in communication with a cloud computing/storage service 1804 which may be hosted by the casino enterprise, a licensed third party or if permitted by gaming regulators an unlicensed provider. For example the cloud service 1804 may be as provided by Microsoft® Private Cloud Solutions offered by Microsoft Corp. of Redmond, Wash., USA. The cloud service 1804 provides various applications which can be accessed and delivered to, for example, personal computers 1806, portable computing devices such as computer tablets 1808, personal digital assistants (PDAs) 1810 and cellular devices 1812 such as telephones and smart phones. As but an example, the cloud service 1804 may store and host an eWallet application, casino or player-centric applications such as downloadable or accessible applications including games, promotional material or applications directed to and/or affecting a casino customers interaction with a casino enterprise (such as accessing the players casino account, establishing casino credit or the like), providing bonuses to players through system wide bonusing (SMB) or specific bonusing or comps to players, or other applications. The cloud service 1804 includes security provide for secure communication with the cloud service 1804 between the player/users and the cloud service 1804 and between the cloud service 1804 and the gaming system 1701. Security applications may be through encryption, the use of personal identification numbers (PINS) or other devices and systems. As suggested in FIG. 5 the cloud service 1004 stores player/user data retrieved from players/users and from the gaming system 1701.

The players/users may access the cloud service 1804 and the applications and data provided thereby through the Internet or through broadband wireless cellular communication systems and any intervening sort range wireless communication such as WiFi. The players/users may access the applications and data through various social media offerings such as Facebook, Twitter, Yelp, MySpace, LinkedIn or the like.

As but an example, a player/user may have a player account with a casino enterprise Z. That account may include data such as the player's credit level, their rating and their available comps. At their smart phone 1812 the player/user sends a request to the clout service 1804 (perhaps through a previously downloaded application) to request the status of their available comps such as how many comp points they have and what may be available through redemption of those points (e.g. lodging, cash back, meals or merchandise). The application for the request may present casino promotions, graphics or other advertising to the player/user. The application, to support such a request, would typically require the player/user to enter a PIN. The cloud service 1004 forwards the inquiry to the bonusing servicer 1800 which, in turn, confirms the PIN and retrieves the requested information from the data warehouse 1735 or player tracking CMS/CMP server 1737. Alternatively the data may be stored in the cloud service 1804 and routinely updated from the data warehouse 1735 or player tracking CMS/CMP server 1737. In this instance the request would be responded to from data residing with the cloud service 1804. The information is formatted by the cloud server 1804 application and delivered to the player/user. The delivery may be formatted based upon the player/user's device operating system (OS), display size or the like.

The cloud service 1800 may also host game applications to provide virtual instances of games for free, promotional, or where permitted, P2P (Pay to Play) supported gaming. Third party developers may also have access to placing applications with the cloud service 1804 through, for example a national operations center (Bally NOC 1814). A game software manufacturer such as Bally Gaming, Inc. may also provide game applications on its own or on behalf of the casino enterprise.

Other media such as advertising, notices (such as an upcoming tournament) may also be provided to the cloud service 1804. When a player/user accesses the cloud service 1804 certain media may be delivered to the player/user in a manner formatted for their application and device.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the invention.

What is claimed:

1. A method of operating a wagering game for a gaming machine comprising a non-transitory memory device and executed by a processor of the gaming machine, the steps comprising:
initializing a tally;
presenting a plurality of games comprising spinning one of more symbol-bearing reels to produce a game outcome and, for each special symbol displayed as part of the game outcome, incrementing the tally;
upon conclusion of the presentation of the plurality of games, presenting an additional game outcome comprising spinning the one of more symbol-bearing reels to produce an additional game outcome, wherein, one or more of the symbols displayed as part of the additional outcome is replaced by one or more wild symbols, the number of symbols replaced by wild symbols determined by the tally.

2. A method of operating a wagering game for a gaming machine comprising a non-transitory memory device and executed by a processor of the gaming machine, the steps comprising:
present a plurality of games, each of the plurality of games comprising designating a symbol as a designated symbol and spinning one of more symbol-bearing reels to produce a game outcome and, for each designated symbol displayed as part of the game outcome, treating that symbol as a wild symbol in evaluating the game outcome for any winning combinations of symbols; and
retaining the wild characteristic of the designated symbol for all subsequent games in the plurality of games.
